(19) United States
(12) Patent Application Publication
(10) Pub. No.: US 2015/0289015 A1
(43) Pub. Date: Oct. 8, 2015

(54) BROADCAST RECEIVING APPARATUS, UPGRADE DEVICE FOR UPGRADING THE APPARATUS, BROADCAST SIGNAL PROCESSING SYSTEM, AND METHODS THEREOF

(71) Applicant: SAMSUNG ELECTRONICS CO., LTD., Suwon-si (KR)

(72) Inventor: Choon-sik JUNG, Hwaseong-si (KR)

(73) Assignee: SAMSUNG ELECTRONICS CO., LTD., Suwon-si (KR)

(21) Appl. No.: 14/489,645

(22) Filed: Sep. 18, 2014

(30) Foreign Application Priority Data
Apr. 2, 2014 (KR) 10-2014-0039173

(51) Int. Cl. H04N 21/458; H04N 21/4385; H04N 21/43; H04N 21/438; H04N 21/418; H04N 21/431

(52) U.S. Cl. CPC H04N 21/4586; H04N 21/4181; H04N 21/4183; H04N 21/4312; H04N 21/4307; H04N 21/438; H04N 21/43853

(57) ABSTRACT

A broadcast signal processing system includes a broadcast receiving apparatus configured to receive a broadcast signal and detect a clock frequency of a transport stream (TS) included in the broadcast signal, and an upgrade apparatus configured to process the TS using the clock frequency and provide content included in the TS to the broadcast receiving apparatus. The broadcast receiving apparatus is configured to output the content provided from the upgrade apparatus.

### CROSS-REFERENCE TO RELATED APPLICATION(S)

This application claims the priority from Korean Patent Application No. 10-2014-0039173 filed on Apr. 2, 2014 in the Korean Intellectual Property Office, the entire disclosure of which is hereby incorporated by reference.

### BACKGROUND

1. Field

Apparatuses and methods consistent with exemplary embodiments relate to broadcasting, and more specifically, to a broadcast receiving apparatus, an upgrade apparatus for enhancing performance thereof, and a broadcast signal processing system that provide a variety of upgrading functions using a clock frequency.

2. Description of Related Art

Electronic technology has been greatly advanced in large part due to the development and supply of various types of electronic apparatuses. An example of the electronic apparatus is a broadcast receiving apparatuses such as a television, a computer, a mobile device, and the like.

A broadcast receiving apparatus supports functions such as broadcast channel tuning, reception of a broadcast signal, and outputting contents included in the broadcast signal. Recent broadcast receiving apparatuses support additional functions such as accessing the internet, conducting searches, outputting three-dimensional (3D) images, interactive media, on-demand streaming, home networking access, and the like. Furthermore, more functions are rapidly diversified and upgraded on a daily basis.

However, broadcast receiving apparatuses supplied previously may not be able to adequately perform newly-added functions. To be specific, when a new function is developed, the hardware or software installed on the existing broadcast receiving apparatus may not have a performance that is sufficient to efficiently perform the newly-developed functions.

In an effort to solve this problem, an upgrade apparatus has been developed that can be connected to a broadcast receiving apparatus to enhance the performance thereof. The upgrade apparatus refers to an apparatus which can upgrade the performance of a broadcast receiving apparatus by simple addition or replacement of hardware.

However, the related upgrade apparatus simply operates to upgrade a portion of the performance of the broadcast receiving apparatus connected thereto, and it is not possible to utilize the upgrade apparatus in a variety of ways.

### SUMMARY

Exemplary embodiments overcome the above disadvantages and other disadvantages not described above. Also, an exemplary embodiment is not required to overcome the disadvantages described above, and an exemplary embodiment may not overcome any of the problems described above.

Exemplary embodiments provide an upgrade apparatus configured to generate a clock signal according to a clock frequency received from a broadcast receiving apparatus and to use the clock signal to provide various updates, a broadcast receiving apparatus configured to provide the clock frequency to the upgrade apparatus, a broadcast signal processing system having the same, and methods thereof.

According to an aspect of an exemplary embodiment, there is provided a broadcast signal processing system including a broadcast receiving apparatus configured to receive a broadcast signal and detect a clock frequency of a transport stream (TS) included in the broadcast signal, and an upgrade apparatus configured to process the TS using the clock frequency and provide content included in the TS to the broadcast receiving apparatus, wherein the broadcast receiving apparatus is configured to output the content provided from the upgrade apparatus.

The broadcast receiving apparatus may include a receiver configured to tune to a broadcast channel and receive the broadcast signal; a first interface configured to be connected to the upgrade apparatus; a signal processor configured to process the broadcast signal and detect the TS; a first processor configured to process the TS; a display configured to display a screen generated by the first processor; a frequency detector configured to detect the clock frequency of the TS; a frequency storage configured to store the clock frequency; and a controller configured to provide the upgrade apparatus with the TS and the clock frequency via the first interface.

The controller may control the display to selectively display one of the content provided from the upgrade apparatus and the screen generated by the first processor of the broadcast receiving apparatus.

In a multi-screen function mode, the controller may detect a plurality of TSs from a plurality of broadcast signals received from a plurality of broadcast channels, control the first processor to process a first TS from among the plurality of TSs to generate a first screen, provide the first screen to the upgrade apparatus, and provide a second TS from among the plurality of TSs and a clock frequency of the second TS to the upgrade apparatus, and the upgrade apparatus may generate a multi-screen by combining a second screen that is a result of processing the second TS with the first screen, and provide the multi-screen to the broadcast receiving apparatus, and the display may display the multi-screen provided from the upgrade apparatus.

The upgrade apparatus may generate a second screen by processing the second TS, and provide the second screen to the broadcast receiving apparatus, the first processor of the broadcast receiving apparatus may generate a multi-screen by combining the first screen with the second screen, and the display may display the generated multi-screen.

The upgrade apparatus may include a second interface configured to be connected to the first interface of the broadcast receiving apparatus; a memory configured to store the TS received from the broadcast receiving apparatus and store the clock frequency; a clock signal generator configured to generate a clock signal based on the clock frequency; a second processor configured to detect the TS stored by the memory according to the clock signal, process the detected TS and reproduce the content; and a host controller configured to provide the content to the broadcast receiving apparatus via the second interface.

According to an aspect of another exemplary embodiment, there is provided a broadcast receiving apparatus including an interface configured to be connected to an upgrade apparatus; a receiver configured to tune to a broadcast channel and receive a broadcast signal; a signal processor configured to process the broadcast signal and detect a TS from the processed broadcast signal; and a stream processor configured to detect a clock frequency of the TS and provide the TS and the clock frequency to the upgrade apparatus.

The stream processor may include a frequency detector configured to detect the clock frequency of the TS; a frequency storage configured to store the clock frequency; and a controller configured to transmit the clock frequency and the TS to the upgrade apparatus via the interface.

The broadcast receiving apparatus may include a display configured to display content included in the TS that is reproduced by and received from the upgrade apparatus via the interface.

The stream processor may include a first processor configured to process the TS, and the controller may control the display to selectively display one of a screen provided from the upgrade apparatus and a screen generated as a result of processing of the TS by the first processor of the broadcast receiving apparatus.

In a multi-screen function mode, the stream processor may process a first TS from among a plurality of TSs detected from a plurality of broadcast signals received through a plurality of broadcast channels, provide the processing result to the upgrade apparatus, and provide a second TS from among the plurality of TSs and a clock frequency of the second TS to the upgrade apparatus, and the display may display a multi-screen in response to receiving the multi-screen from the upgrade apparatus which combines a second screen which is a result of processing the second TS with the first screen.

In response to a second screen which is a result of processing the second TS being provided from the upgrade apparatus, the display may display a multi-screen which combines the first screen with the second screen.

The broadcast receiving apparatus may include a condition access module (CAM) configured to process an encrypted content. The displayed screen may further include a content screen decrypted at the CAM.

The frequency detector may detect the frequency using:

$${t}_{TS} = {N}_{TS} * {T}_{ref} \text{/} {N}_{ref} , {F}_{TS} = \frac{1}{{t}_{TS}}$$

where, t_{TS} denotes a clock periodicity, N_{TS} is a number of TS clocks, T_{ref} is a reference clock periodicity, N_{ref} is a number of reference clocks, and F_{TS} is a clock frequency.

According to an aspect of another exemplary embodiment, there provided an upgrade apparatus including an interface configured to be connected to a broadcast receiving apparatus and receive a transport stream (TS) of a broadcast signal and a clock frequency from the broadcast receiving apparatus; a memory configured to store the TS and the clock frequency; and a stream processor configured to reproduce a included in the TS by processing the TS using the clock frequency and provide the content to the broadcast receiving apparatus via the interface.

The stream processor may include a clock signal generator configured to generate a clock signal based on the clock frequency; a second processor configured to detect the TS stored at the memory according to a data rate corresponding to the generated clock signal, and process the detected TS to reproduce the content; and a host controller configured to provide the broadcast receiving apparatus with the content via the interface.

In a multi-screen function mode, the host controller may control the processor to process the TS received from the broadcast receiving apparatus to generate a second screen, and provide the broadcast receiving apparatus with a multi-screen in which a first screen processed by the broadcast receiving apparatus and the second screen are combined.

According to an aspect of another exemplary embodiment, there is provided a broadcast signal processing method of a broadcast signal processing system including a broadcast receiving apparatus and a upgrade apparatus connected to the broadcast receiving apparatus, the broadcast signal processing method including receiving, at the broadcast receiving apparatus, a broadcast signal and detecting a clock frequency of a transport stream (TS) included in the broadcast signal; generating, at the upgrade apparatus, a clock signal based on the clock frequency and reproducing a content included in the TS by processing the TS based on the generated clock signal; and outputting, at the broadcast receiving apparatus, the reproduced content.

In a multi-screen function mode, the method may further include detecting, at the broadcast receiving apparatus, a plurality of TSs from a plurality of broadcast signals received from a plurality of broadcast channels; processing, at the broadcast receiving apparatus, a first TS among the plurality of TSs to generate a first screen, and providing the first screen to the upgrade apparatus; providing, at the broadcast receiving apparatus, a second TS among the plurality of TSs and a clock frequency of the second TS to the upgrade apparatus; generating, at the upgrade apparatus, a second screen by processing the second TS; and displaying, at the broadcast receiving apparatus, a multi-screen which is a result of combining the first screen and the second screen.

According to an aspect of another exemplary embodiment, there is provided a broadcast signal processing method of a broadcast receiving apparatus to which an upgrade apparatus is connected, the broadcast signal processing method including tuning to a broadcast channel and receiving a broadcast signal; decoding the broadcast signal and detecting a transport stream (TS) from the decoded broadcast signal; detecting a clock frequency of the TS and providing the upgrade apparatus with the TS and the clock frequency; and in response to receiving content from the upgrade apparatus which is reproduced based on the provided TS, displaying the content.

In a multi screen function mode, the method may further include detecting a plurality of TSs from a plurality of broadcast signals received from a plurality of broadcast channels; processing a first TS from among the plurality of TSs to generate a first screen and providing the processing result to the upgrade apparatus; providing a second TS from among the plurality of TSs and a clock frequency of the second TS to the upgrade apparatus; generating a second screen which is a result of processing the second TS by the upgrading apparatus; and displaying a multi screen which combines the first screen and the second screen.

According to an aspect of another exemplary embodiment, there is provided a broadcast signal processing method of an upgrade apparatus connected to a broadcast receiving apparatus, the broadcast signal processing method including receiving a transport stream (TS) of a broadcast signal and a clock frequency from the broadcast receiving apparatus; storing the TS and the clock frequency; generating a clock signal based on the generated clock frequency; reproducing content included in the TS by processing the TS using the clock signal; and providing the reproduced content to the broadcast receiving apparatus.

The broadcast signal processing method may further include, in response to receiving a screen processed by the broadcast receiving apparatus from the broadcast receiving apparatus while in a multi-screen function mode, providing a multi-screen in which a screen of the content processed by the upgrade apparatus and the screen received from the broadcast receiving apparatus are combined.

According to an aspect of another exemplary embodiment, there is provided an apparatus that externally connects to a broadcast display apparatus and processes content, the apparatus including a receiver configured to receive broadcast signal information from the broadcast display apparatus, and a processor configured to process content that is displayed by the broadcast display apparatus based on a transport stream and clock cycle information included in the broadcast signal information received from the broadcast display apparatus.

The processor may be configured to process the content by performing a function with the content that the broadcast display apparatus does not support on its own.

The apparatus may further include an interface configured to externally attach and detach the apparatus to the broadcast display apparatus.

The clock cycle information may include a clock frequency of the broadcast display apparatus, and the processor may be further configured to generate a clock cycle based on the clock frequency and process the transport stream based on the generated clock cycle.

The clock cycle information may include a clock cycle of the broadcast display apparatus, and the processor may be further configured to process the transport stream based on the received clock cycle.

The processor may be configured to process content by decoding the transport stream, reproducing content included in the transport stream, and transmitting the reproduced content to the broadcast display apparatus.

### BRIEF DESCRIPTION OF THE DRAWINGS

The above and/or other aspects will be more apparent by describing certain exemplary embodiments with reference to the accompanying drawings, in which:

FIG. 1 is a block diagram of a broadcast signal processing system according to an exemplary embodiment;

FIGS. 2 and 3 are diagrams illustrating connecting a broadcast receiving apparatus to an upgrade apparatus according to exemplary embodiments;

FIG. 4 illustrates an outer construction of an upgrade apparatus according to an exemplary embodiment;

FIG. 5 is a sequence diagram illustrating a broadcast signal processing method according to an exemplary embodiment;

FIG. 6 is a block diagram illustrating a broadcast receiving apparatus according to an exemplary embodiment;

FIG. 7 is a block diagram illustrating an upgrade apparatus according to an exemplary embodiment;

FIG. 8 is a diagram illustrating a transport stream of a Moving Picture Experts Group (MPEG) standard according to an exemplary embodiment;

FIG. 9 is a diagram illustrating a data processing process using a clock signal according to an exemplary embodiment;

FIG. 10 is a sequence diagram illustrating a broadcast signal processing method according to another exemplary embodiment;

FIG. 11 is a block diagram of a broadcast signal processing system according to another exemplary embodiment;

FIGS. 12 and 13 illustrate a variety of UI screens varied in response to mounting and removal of an upgrade apparatus according to an exemplary embodiment;

FIGS. 14 to 17 illustrate multi-screens according to various exemplary embodiments;

FIG. 18 is a block diagram of a broadcast receiving apparatus according to another exemplary embodiment;

FIG. 19 illustrates operation of a broadcast signal processing system performing a multi view function according to an exemplary embodiment;

FIG. 20 illustrates operation of a broadcast signal processing system performing a 3D display function according to an exemplary embodiment;

FIG. 21 is a flowchart illustrating a broadcast signal processing method of a broadcast receiving apparatus according to an exemplary embodiment; and;

FIG. 22 is a flowchart illustrating a broadcast signal processing method of an upgrade apparatus according to an exemplary embodiment.

### DETAILED DESCRIPTION

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the exemplary embodiments. Accordingly, it is apparent that the exemplary embodiments can be carried out without those specifically defined matters. Also, well-known functions or constructions are not described in detail since they would obscure the description with unnecessary detail.

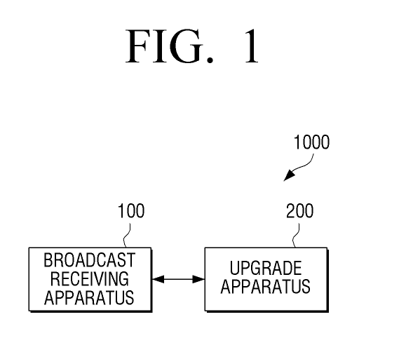

FIG. 1 is a block diagram of a broadcast signal processing system according to an exemplary embodiment.

Referring to FIG. 1, a broadcast signal processing system 1000 includes a broadcast receiving apparatus 100 and an upgrade apparatus 200. The broadcast receiving apparatus 100 may be or may be included in a variety of types of apparatuses which can receive a broadcast signal, for example, a television, a set-top box, a computer, a game console, a tablet, an appliance, and the like.

The broadcast receiving apparatus 100 may receive a variety of signals provided from an external image supply source (not illustrated) via antenna, cable, internet, and the like. For example, if the broadcast receiving apparatus 100 is a TV having a display and a speaker implemented thereon or attached thereto, the broadcast receiving apparatus 100 may process a broadcast signal using image processing blocks stored therein to output a video signal and an audio signal. Accordingly, the broadcast receiving apparatus 100 may also be referred to as a display apparatus. For convenience of explanation, however, the broadcast receiving apparatus 100 will be representatively referred herein. As another example, when implemented as a set-top box, the broadcast receiving apparatus 100 may process a broadcast signal and provide a video and an audio signal to an external TV or monitor.

The upgrade apparatus 200 may connect to the broadcast receiving apparatus 100 and upgrade a performance of the broadcast receiving apparatus 100. The upgrade apparatus 200 may be referred to as, for example, an upgrade kit, an evolution kit, and the like. The upgrade apparatus 200 may include an image processing block such as a decoder or scaler, a microcomputer to control the respective image processing blocks, a central processing unit (CPU), a graphic processing unit (GPU), and the like.

Thus, by using the image processing blocks, the microcomputer, CPU, or GPU, the upgrade apparatus 200 may replace or complement performance of hardware or software of the broadcast receiving apparatus 100. As a result, more enhanced image quality or a newer user interface (UI) screen can be provided, and newer functions that cannot be executed with the broadcast receiving apparatus 100 alone may be implemented.

The upgrade apparatus 200 may be connected to the broadcast receiving apparatus 100 in a variety of manners. As a non-limiting example, the broadcast receiving apparatus 100 may be connected to the upgrade apparatus 200 through a universal serial bus (USB) interface, a peripheral connect interface (PCI), a serializer/deserializer (Serdes) interface, and the like.

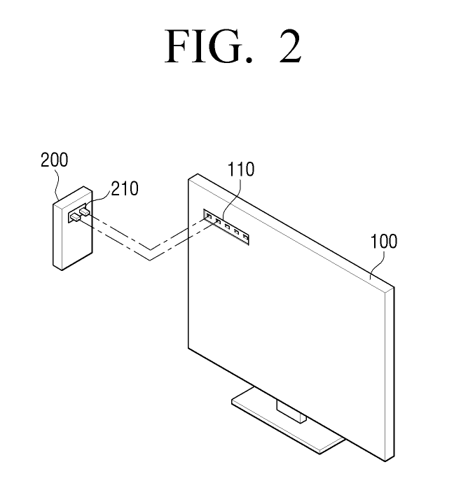

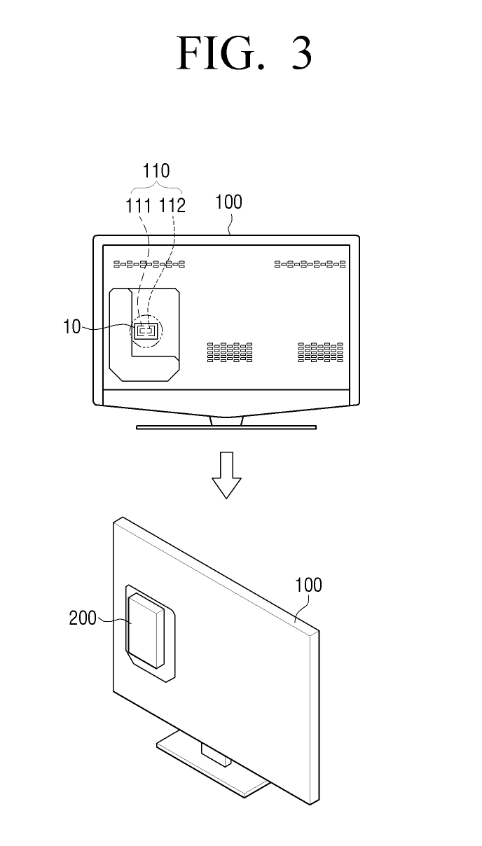

FIGS. 2 and 3 are diagrams illustrating connecting the upgrade apparatus 200 to the broadcast receiving apparatus 100 according to an exemplary embodiment.

Referring to FIG. 2, the display apparatus includes an interface 110 on a rear surface which is connectible to a variety of external devices. For convenience of explanation, the interface 110 on the display apparatus will be referred to as a first interface 110, and an interface on the upgrade apparatus 200 will be referred to as a second interface 210.

Referring to FIG. 2, the first interface 110 includes an opening therein that has a variety of signal input and output terminals, and the second interface 210 includes projected terminals that may be directly inserted into the opening of the first interface 110, but embodiments are not limited thereto. As another example, the first and second interfaces 110 and 210 may be connected to each other via a cable (i.e., wired), by wireless communication sessions thereof according to a variety of wireless communication standards such as Bluetooth, Zigbee, WiFi, and the like.

FIG. 3 illustrates a process of connecting the upgrade apparatus 200 to the display apparatus according to an exemplary embodiment. Referring to FIG. 3, the first interface 110 of the display apparatus may be covered with a cover 10 which may be a sticker, tape, an adhesive, or other material. On a lower side of the cover 10 is formed an opening 111, and one or more signal input and output terminals 112 are provided in the opening 111.

The opening 111 is exposed by removing the cover 10 by a user who may connect the upgrade apparatus 200. A groove or other fixing means may be provided around the opening 111 for mounting of the upgrade apparatus 200. For example, the user may fit a hook formed on a main body of the upgrade apparatus 200 in the groove, along a direction of the second interface 210 and be inserted into the first interface 110. Accordingly, the upgrade apparatus 200 may be connected or otherwise fixed to the rear surface of the broadcast receiving apparatus 100.

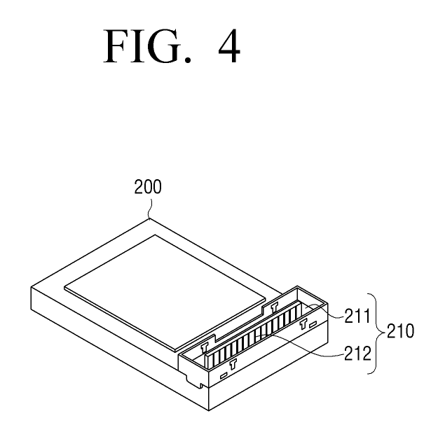

FIG. 4 illustrates an outer appearance of the upgrade apparatus 200 according to an exemplary embodiment. Referring to FIG. 4, the second interface 210 is provided on one side of the upgrade apparatus 200. In this example, the second interface 210 includes an opening 211 and a signal input and output terminal 212.

One or more signal input and output terminals 212 may be provided in the opening 211. The signal input and output terminal 212 may be connected to the signal input and output terminal 112 of the first interface 110, and may allow transmission and reception of signals or data between the two interfaces.

According to various aspects, the upgrade apparatus 200 having multiple types of shapes and sizes may be connected to the broadcast receiving apparatus 100 through multiple types of connection means. In response to a broadcast signal being received therein, the broadcast receiving apparatus 100 may provide a transport stream and a clock frequency to the upgrade apparatus 200 connected thereto.

The upgrade apparatus 200 may generate a clock signal using the clock frequency, and process the transport stream using the clock signal. As a result, contents are reproduced from the transport stream (TS). The upgrade apparatus 200 may provide the reproduced content to the broadcast receiving apparatus 100. In response, the broadcast receiving apparatus 100 may output the contents using at least one of the display and speaker provided therein. Accordingly, the broadcast receiving apparatus 100 may output the contents as provided from the upgrade apparatus 200. As another example, the broadcast receiving apparatus 100 may output content processed therein.

The upgrade apparatus 200 may use a clock signal to process the TS in sync. As one example, the broadcast receiving apparatus 100 may not provide the clock signal to the upgrade apparatus 200, but instead provide frequency information of the clock. Accordingly, the upgrade apparatus 200 may generate the clock signal without requiring a separate channel input. As another example, the upgrade apparatus 200 may receive the clock signal directly from the broadcast receiving apparatus 100.

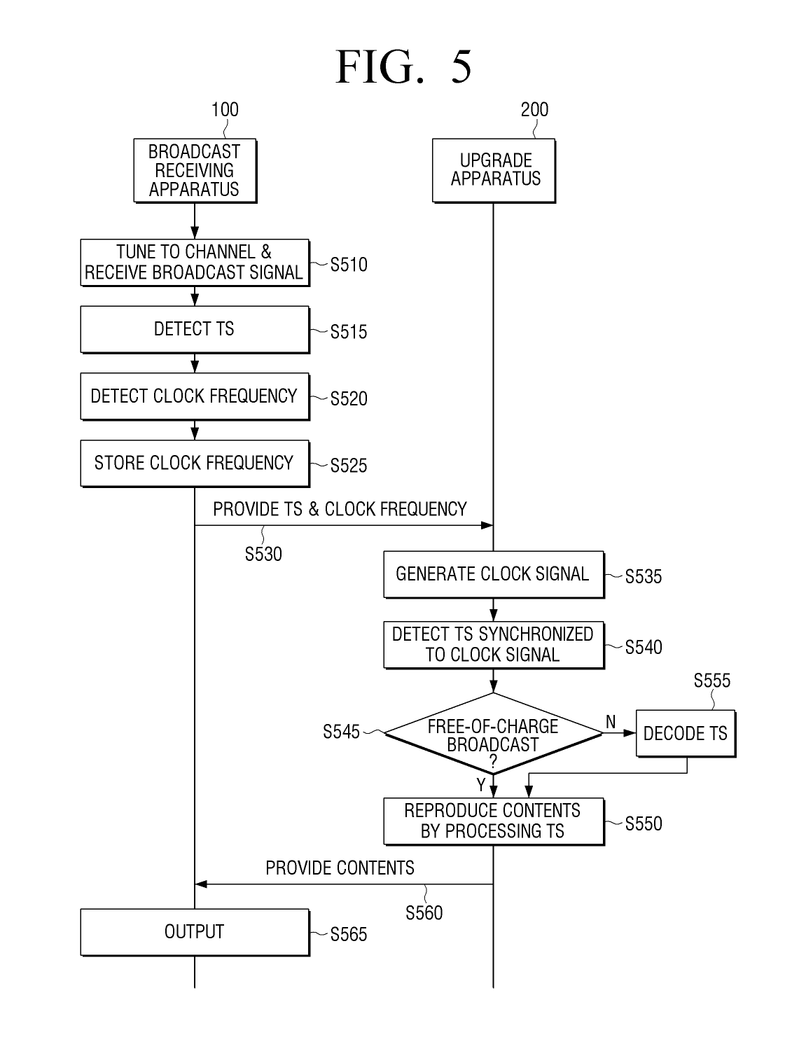

FIG. 5 is a sequence diagram illustrating a broadcast signal processing method according to an exemplary embodiment. Referring to FIG. 5, it is assumed that the broadcast signal processing system is already connected to the broadcast receiving apparatus 100.

Referring to FIG. 5, at S510, the broadcast receiving apparatus 100 tunes to a broadcast channel and receives a broadcast signal corresponding to the broadcast channel. The user may select a broadcast channel to watch using a button provided on a main body of the broadcast receiving apparatus 100, using a remote control, and the like. The broadcast receiving apparatus 100 may tune to the broadcast channel in response to a selection by the user, using a broadcast channel tuning means such as a tuner.

At S515, the broadcast receiving apparatus detects a TS from the broadcast signal received through the tuned broadcast channel. The TS may include successive collections of data of a digital broadcast. For example, the TS may refer to the stream which is transmitted after an individually-encoded video elementary stream (ES), audio ES, general data ES, and the like, undergo TS packet-based time divisional multiplexing. The video ES may be generated according to the MPEG standard, and audio ES may be generated according to the digital audio compression (AC3) standard, but not limited thereto.

At S520, in response to detecting the TS, the broadcast receiving apparatus 100 detects a corresponding clock frequency. The clock frequency as referred to herein may include frequency information of a clock signal received from an external source, such as a broadcasting station, which sends out a broadcast signal.

At S525, the broadcast receiving apparatus 100 stores the detected clock frequency and at S530, the stored clock frequency and TS are provided to the upgrade apparatus 200. The upgrade apparatus 200 may directly read out the clock frequency stored in the broadcast receiving apparatus 100. As another example, the broadcast receiving apparatus 100 may transmit the clock frequency in response to a request by the upgrade apparatus 200.

At 5535, the upgrade apparatus 200 generates a clock signal using the provided clock frequency, and at 5540, the upgrade apparatus 200 synchronizes with the generated clock signal and detects the TS.

At 5545, the upgrade apparatus 200 determines whether the detected TS is a free-of-charge broadcast or a charged broadcast. For example, the free-of-charge broadcast may include a broadcast signal containing contents that are not encrypted, and the charged broadcast may include a broadcast signal containing contents that are encrypted. Accordingly, the free-of-charge may be expressed as a non-encrypted content broadcast, and the charged broadcast may be expressed as encrypted content broadcast.

If it is a free-of-charge broadcast, at 5550, the upgrade apparatus 200 reproduces the contents included in the TS by directly processing the TS. For example, when the contents are video contents, the upgrade apparatus 200 may decode the video and audio data of the video contents to generate video and audio signals. As another example, when the contents are still image contents, the upgrade apparatus 200 decodes the contents and generates a video signal. When the contents are an audio file, the upgrade apparatus 200 may decode the same and generate the audio signal.

On the contrary, if it is a charged broadcast, at 5555, the upgrade apparatus 200 decrypts the TS, for example, using a conditional access module (CAM). Accordingly, at 5550, the contents of the decrypted TS are reproduced. At 5560, the upgrade apparatus 200 provides the reproduced contents to the broadcast receiving apparatus 100. The broadcast receiving apparatus 100 may also detect information such as data rate, in addition to the frequency information of the clock signal, and may store the same. The data rate may be provided to the upgrade apparatus 200. Accordingly, the upgrade apparatus 200 may provide the CAM with the TS in accordance with the provided data rate.

At S565, the broadcast receiving apparatus 100 outputs the reproduced contents. For example, when receiving video contents, the broadcast receiving apparatus 100 may display a video signal of the video contents, while also outputting an audio signal through a speaker in synchronization therewith.

It should be appreciated that when the upgrade apparatus 200 connected, the upgrade apparatus 200 does not have to directly receive the broadcast signal. As another example, it is possible to generate a clock signal using a clock frequency and transmit the TS in sync with the clock signal. Accordingly, it is possible to implement a multi-screen function, a multi-view function, a 3D display function, and the like, using decoders of both the broadcast receiving apparatus 100 and the upgrade apparatus 200. Examples of methods for implementing these functions are further described below.

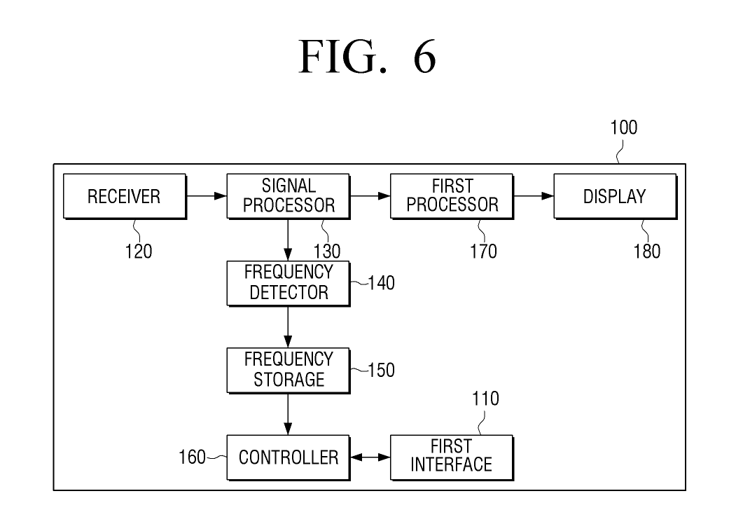

FIG. 6 is a block diagram of a broadcast receiving apparatus 100 according to an exemplary embodiment. Referring to FIG. 6, the broadcast receiving apparatus 100 includes a first interface 110, a receiver 120, a signal processor 130, a frequency detector 140, a frequency storage 150, a controller 160, a first processor 170, and a display 180.

The first interface 110 is for connecting to the upgrade apparatus 200. For example, the first interface 110 may be a USB interface, a PCl2 interface, a Serdes interface, and the like.

The receiver 120 may tune to a broadcast channel and receive a broadcast signal according to the tuned broadcast channel. The receiver 120 may include at least one tuner. The broadcast signal received through the receiver 120 may be provided to the signal processor 130.

The signal processor 130 may process a broadcast signal and detect a TS. For example, the signal processor 130 may demodulate, equalize and decode the broadcast signal using a demodulator, an equalizer, a channel decoder, and the like, and detect the TS. The TS detected by the signal processor 130 may be provided to the frequency detector 140 and the first processor 170.

The first processor 170 may process the TS. For example, the first processor 170 may include a variety of signal processing blocks including a demultiplexer, a video decoder, an audio decoder, a scaler, and the like. The demultiplexer may separate video data, audio data, general data, and the like from the TS. The separated data may be provided to the video decoder, the audio decoder, and a general decoder, respectively, depending on characteristics thereof. Accordingly, a variety of output signals such as a video screen or an audio screen may be generated, as the input data is decoded at the respective decoders.

The display 180 displays the screen generated by the first processor 170. Although not illustrated in FIG. 6, the broadcast receiving apparatus 100 may additionally include a speaker that may be used to output an audio signal.

The frequency detector 140 may detect a clock frequency of a clock signal included in a received broadcast signal. The frequency detector 140 may calculate the clock frequency using a number of clock signals received over a predetermined duration of time, periodicity of a reference clock, a number of reference clocks, and the like. For example, the frequency detector 140 may calculate the clock frequency using the following mathematical expression:

$${t}_{TS} = {N}_{TS} * {T}_{ref} \text{/} {N}_{ref} , {F}_{TS} = \frac{1}{{t}_{TS}} \qquad [ Equation 1 ]$$

In Equation 1, t_{TS} denotes a clock periodicity, N_{TS} is number of TS clocks, T_{ref} is a reference clock periodicity, N_{ref} is a number of reference clocks, and F_{TS} is a clock frequency. The reference clock as used herein refers to a reference clock signal that is internally used by the controller 160 of the broadcast receiving apparatus 100. For example, when a central processing unit (CPU) using a 1 GHZ reference clock is included therein, the reference clock may be 1 GHz clock signal. The frequency detector 140 may calculate a clock periodicity by comparing the number of peaks and the periodicity of reference clock and the number of peaks of the clock, and calculate the clock frequency using the same. For example, when there is a greater number of TS clocks and a smaller reference clock periodicity, a more accurate clock frequency may be obtained. As another example, the frequency detector 140 may extract not only the clock frequency, but also additional information such as a data rate, and the like.

The frequency storage 150 may store information extracted from the frequency detector 140. The frequency storage 150 may be implemented as various types of memories. For example, the frequency storage 150 may include a non-transitory computer-readable storage medium such as a read-only memory (ROM), random-access memory (RAM), flash memory, magneto-optical data storage devices, optical data storage devices, hard disks, solid-state disks, or any other non-transitory computer-readable storage medium known to one of ordinary skill in the art.

The controller 160 controls the overall operation of the broadcast receiving apparatus 100. The controller 160 may provide the clock frequency stored in the frequency storage 150 to the upgrade apparatus 200 via the first interface 110. The controller 160 may be or may include one or more of a processor, a controller and an arithmetic logic unit, a digital signal processor, a microcomputer, a field-programmable array, a programmable logic unit, a microprocessor, or any other device capable of running software or executing instructions.

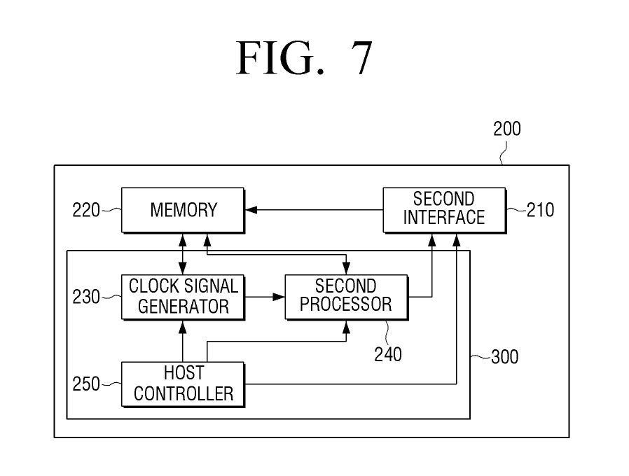

While the upgrade apparatus 200 is connected to the broadcast receiving apparatus 100, the controller 160 may output contents provided from the upgrade apparatus 200 using the display 180 or another output means (e.g., speaker, etc.). The contents may include general broadcast contents, and also music files, photos, graphic images, UI screens, video contents, and the like. When the TS and clock frequency are provided to the upgrade apparatus 200, the upgrade apparatus 200 may directly generate a clock signal using the clock frequency. Accordingly, it is possible to reproduce contents by processing the TS based on the generated clock signal and provide the reproduced contents to the broadcast receiving apparatus 100. An example of the upgrade apparatus 200 is further explained below with respect to FIG. 7.

While the upgrade apparatus 200 is separated from the broadcast receiving apparatus 100, the controller 160 may control the display 180 to display a screen generated by the first processor 170. As another example, the screen may be selected according to a user's selection, irrespective of whether the upgrade apparatus 200 is connected or disconnected to the broadcast receiving apparatus 100. That is, while the upgrade apparatus 200 is connected to the broadcast receiving apparatus 100, the controller 160 may control the display 180 to selectively display a screen provided by the upgrade apparatus 200 and a screen generated by the first processor 170.

FIG. 7 is a block diagram of an upgrade apparatus 200 according to an exemplary embodiment.

Referring to FIG. 7, the upgrade apparatus 200 includes a second interface 210, a memory 220 and a stream processor 300. The second interface 210 is configured to connect to the first interface 110 of the broadcast receiving apparatus 100. For example, the second interface 210 may include a USB, PGI2, Serdes interface, and the like. The TS and clock frequency received via the second interface 210 are stored at the memory 220.

The stream processor 300 may generate a clock signal using a clock frequency stored in the memory 220 and process the TS using the clock signal. In this example, the stream processor 330 includes a clock signal generator 230, a second processor 240, and a host controller 250.

The clock signal generator 230 may generate the clock signal using the clock frequency stored in the memory 220. The clock signal generator 230 may generate a clock signal with the same frequency as a clock signal received from the broadcast receiving apparatus 100, for example, using an oscillator. The generated clock signal may be provided to the second processor 240.

The second processor 240 detects the TS stored in the memory 220 based on the clock signal, processes the detected TS, and reproduces the contents included in the TS. For example, the second processor 240 may include a TS interface, a demultiplexer, a video decoder, an audio decoder, a scaler, and other signal processing blocks.

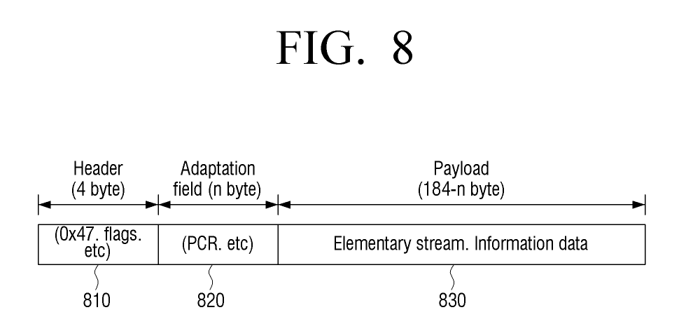

FIG. 8 illustrates a TS generated according to a MPEG 2 standard according to an exemplary embodiment. The TS includes a header 810, an adaptation field 820, and a payload 830. The adaptation field 820 may include sync information such as a program clock reference (PCR), and the like. The PCR is the information included in the MPEG TS and may be used to align a time reference to that of the broadcast receiving apparatus 100. For example, the PCR may refer to a 42-bit time reference value to set or align system time clock (STC) value. The PCR may provide a sample of a system time clock in an encoder which is used to demultiplex packets.

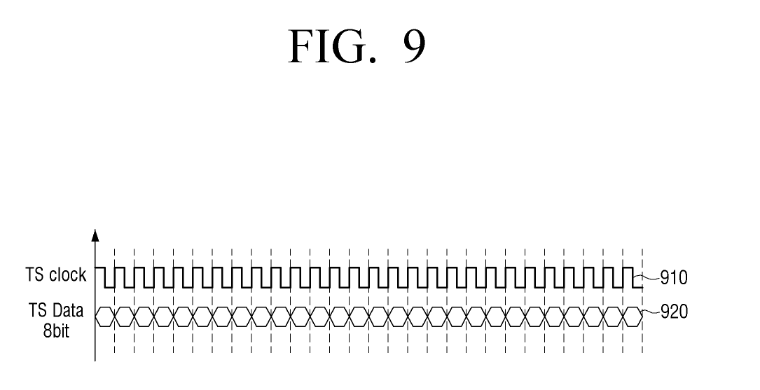

FIG. 9 illustrates an example of a clock signal generated by the clock signal generator 230 according to an exemplary embodiment. The second processor 240 may detect a TS stored in the memory 220, based on the clock signal 910. FIG. 9 illustrates data signal 920 detected in an 8-bit unit.

From the data signal, the second processor 240 may detect sync information within the adaptation field 820 located next to the header, and generate a system time clock (STC) using the sync information and the clock signal. The second processor 240 may detect a video PES and an audio PES included in the payload 830, and perform depacketization using the STC for reproducing contents. The host controller 250 may provide the reproduced contents to the broadcast receiving apparatus 100 via the second interface 210.

Referring again to FIG. 7, the upgrade apparatus 200 may include a demultiplexer, a decoder, a scaler, and other signal processing blocks. Accordingly, the broadcast receiving apparatus 100 may provide services based on a plurality of contents. Among such services, a multi-screen function may be supported. The multi-screen function refers to a function of displaying a plurality of screens which include a plurality of contents therein. For example, the multi-screen function may include a picture in picture (PIP) function which displays at least one sub-screen on a main screen, a picture by picture (PBP) function which displays a plurality of contents screens in the same size in parallel, and the like.

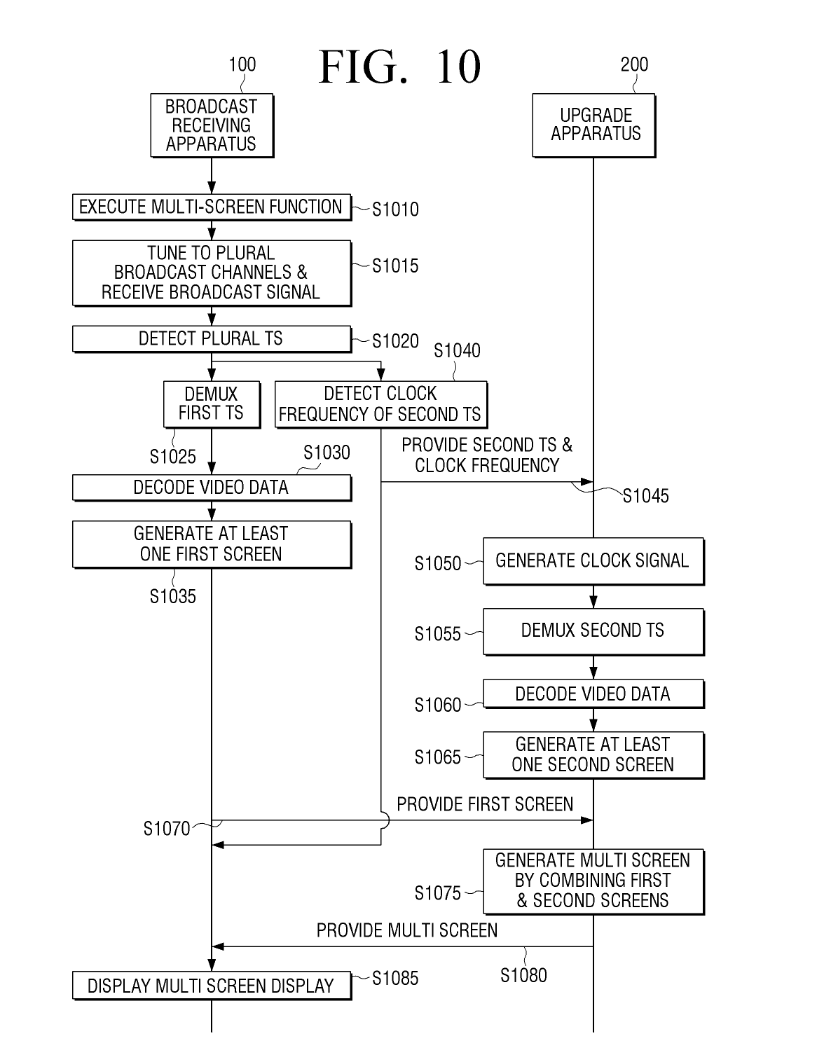

FIG. 10 is a sequence diagram illustrating a method for performing a multi-screen function according to an exemplary embodiment. Referring to FIG. 10, at S1010, the multi-screen function is executed by the broadcast receiving apparatus 100, and at S1015, the broadcast receiving apparatus 100 tunes to a plurality of broadcast channels and receives the broadcast signals. A user may select a multi-screen function, for example, using buttons provided on a body of the broadcast receiving apparatus 100, a remote control, and the like. The user may select a plurality of different broadcast channels to implement the multi-screen function, or alternatively, may select only one broadcast channel which may transmit TS that includes a plurality of contents therein. FIG. 10 illustrates an example in which a plurality of broadcast channels are tuned.

At S1020, the signal processor 130 of the broadcast receiving apparatus 100 may detect a plurality of TSs from the broadcast signals received through a plurality of broadcast channels. The controller 160 may control the first processor 170 to process a first TS from among the plurality of TSs. At S1025, the first processor 170 demuxes the first TS, and at S1030, decodes the video data included in the first TS. At S1035, the first processor 170 generates at least one screen by performing signal processing such as scaling, frame rate conversion, and the like, with respect to the decoded data. For convenience of explanation, a screen generated by the broadcast receiving apparatus 100 is herein referred to as a first screen, while a screen generated by the upgrade apparatus 200 is referred to as a second screen. At S1070, the controller 160 provides the generated first screen to the upgrade apparatus 200 via the first interface 110.

In addition to processing the first TS, at S1040, the controller 160 of the broadcast receiving apparatus 100 detects a clock frequency of a second TS. An example of a method for detecting the clock frequency is described with reference to FIG. 6. At S1045, the controller 160 provides the generated clock frequency and the second TS to the upgrade apparatus 200.

The upgrade apparatus 200 may receive the clock frequency and the second TS via the second interface 210. The memory 220 stores the received clock frequency and second TS. At S1050, the clock signal generator 230 generates a clock signal using the stored clock frequency. At S1055, the second processor 240 demuxes the second TS to separate video and audio data, and at S1060, decodes the video data. At S1065, the second processor 240 generates at least one second screen using the decoded data. Accordingly, when a multi-screen function is implemented using a plurality of contents included in one TS, the broadcast receiving apparatus 100 may tune to only one broadcast channel, process the TS received through such broadcast channel, while separately and directly providing the same TS to the upgrade apparatus 200.

At S1075, the host controller 250 controls the second processor 240 to generate the multi-screen by combining the first and second screens. At 51080, the host controller 250 provides the generated multi-screen to the broadcast receiving apparatus 100 via the second interface 210. In response, at S1085, the broadcast receiving apparatus 100 displays the received multi-screen.

FIG. 10 illustrates an example in which the multi-screen is generated as the upgrade apparatus 200 combines screens, but the embodiments herein are not limited thereto. For example, when contents are processed by a new codec and multi-screen synthesis is not possible at the broadcast receiving apparatus 100 with an existent codec, the upgrade apparatus 200 with the new codec may combine the respective screens to generate the multi-screen. As another example, the broadcast receiving apparatus 100 may also perform multi-screen synthesis with the contents processed by the existent codec. In this example, the first processor 170 of the broadcast receiving apparatus 100 may generate the multi-screen by combining first and second screens and display the resultant screen.

While the multi-screen function is implemented, the user may select contents from which an audio signal is to be provided, from among the contents included in the multi-screen. For example, when a PIP function is implemented, the user may decide whether to listen to an audio signal of the content displayed on a main screen, or to an audio signal of the content displayed on a sub screen. In response to selecting of the sub screen, the second processor 240 may decode the audio data in the second TS and provide the audio signal to the broadcast receiving apparatus 100. On the contrary, in response to selecting of the main screen, the first processor 170 of the broadcast receiving apparatus 100 may decode the audio data in the first TS and output the same using speaker. Alternatively, when a headphone or an earphone is connected to the broadcast receiving apparatus 100, the controller 160 may output an audio signal of one of the first and second TSs through the speaker, while outputting the audio signal of the other TS through the headphone or the earphone.

Furthermore, the broadcast receiving apparatus 100 and the upgrade apparatus 200 may respectively include a condition access system (CAS). Accordingly, in response to implementation of the multi-screen function, a multi-screen including at least one of a free-of-charge content and at least one of a charged content may be displayed.

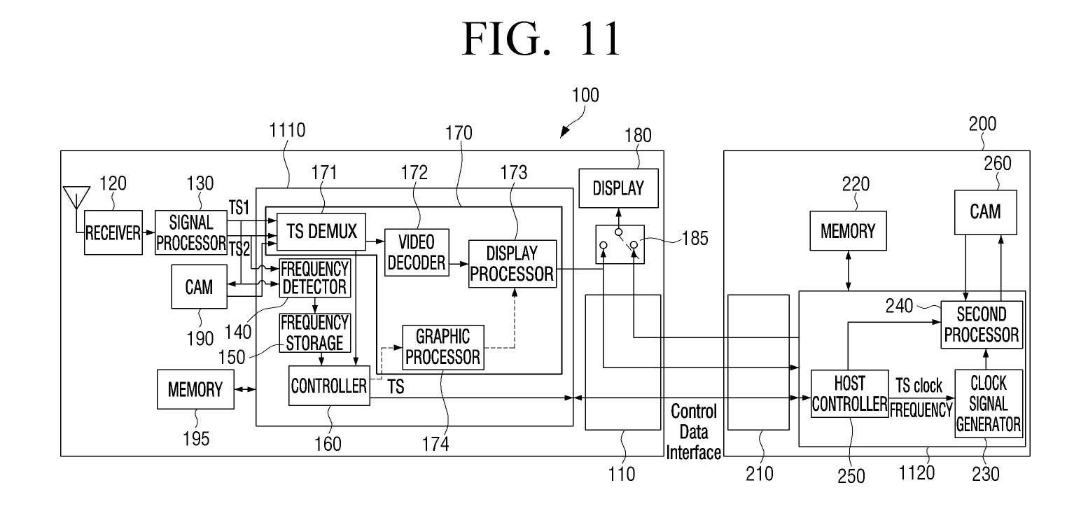

FIG. 11 is a block diagram of a broadcast receiving apparatus 100 and an upgrade apparatus 200 that additionally includes a condition access module (CAM), according to an exemplary embodiment.

Referring to FIG. 11, the broadcast receiving apparatus 100 includes a first interface 110, a receiver 120, a signal processor 130, a frequency detector 140, a frequency storage 150, a controller 160, a first processor 170, a display 180, a switch 185, a CAM 190, and a memory 195. Also, the first processor 170 includes a TS demux 171, a video decoder 172, a display processor 173 and a graphic processor 174.

Referring to FIG. 11, the signal processor 130, the frequency detector 140, the frequency storage 150, the controller 160 and the first processor 170 may be integrated into one integrated circuit (IC) 1110, however, this is merely for purposes of example. As another example, the memory 195 may also be included in the IC 1110, or at least one of the frequency detector 140, the frequency storage 150 and the controller 160 may be provided outside the IC 110.

The CAM 190 is provided to decrypt contents that are encrypted. For example, a condition access system (CAS) that restricts viewing access to a digital broadcast may perform scrambling and encryption on the TS. The CAM 190 thus refers to a module provided to process the TS encrypted by the CAS into viewable form, by performing descrambling and decryption.

In response to a broadcast signal being received through the receiver 120 from a tuned broadcast channel, the signal processor 130 processes the broadcast signal and detects TS. The TS detected at the signal processor 130 may be provided to the TS demux 171 and the frequency detector 140, respectively. Referring to FIG. 11, ‘TS1’ refers to a first TS detected from the broadcast signal received through a charged broadcast channel, and ‘TS2’ refers to a second TS detected from the broadcast signal received through a free-of-charge channel.

The frequency detector 140 detects a clock frequency of the TS and the frequency storage 150 stores the detected clock frequency. The controller 160 may provide the stored clock frequency to the upgrade apparatus 200.

Meanwhile, the signal processor may provide the TS1 to the CAM 190 and the frequency detector 140, in response to the detected broadcast signal being a charged broadcast signal.

The CAM 190 may perform descrambling and decryption of the TS. The decrypted TS is provided to the TS demux 171. The TS demux 171 demultiplexes the TS and provides video data to the video decoder 172. The video decoder 172 decodes the video data and provides the decoded data to the display processor 173. The display processor 173 generates a video frame by performing data processing operations such as scaling, frame rate conversion, and the like.

When the upgrade apparatus 200 is disconnected from the broadcast receiving apparatus 100, the video frame generated by the display processor 173 may be provided to the display 180 and may be displayed. As another example, when the upgrade apparatus 200 is connected and the multi-screen function is implemented, the video frame generated by the display processor 173 may be provided to the upgrade apparatus 200. As another example, when the multi-screen is not implemented, the TS may be processed by the upgrade apparatus 200, and thus, the first processor 170 may not process the TS.

The graphic processor 174 generates graphic objects and provides the same to the display processor 173. For example, the graphic processor 174 may generate a UI screen including various graphic objects such as icons for respective implementable functions of the broadcast receiving apparatus 100, electronic program guide (EPG) information, and the like.

The memory 195 may store programs and data that may be used for the operation of the broadcast receiving apparatus 100. The controller 160 may control the overall operation of the broadcast receiving apparatus 100 using the programs and data stored in the memory 195.

When the upgrade apparatus 200 is disconnected from the broadcast receiving apparatus 100, the controller 160 may control the first processor 170 to directly process the TS and generate a screen. The generated screen may be displayed through the display 180. When the upgrade apparatus 200 is connected to the broadcast receiving apparatus 100, the screen provided from the upgrade apparatus 200 may be displayed through the display 180.

In an example in which the upgrade apparatus 200 connected, and the multi-screen function is implemented, the controller 160 may control the first processor to process one TS while separately providing another TS and clock frequency to the upgrade apparatus 200. Further, the controller 160 may transfer control to the host controller 250, in response to connecting of the upgrade apparatus 200.

The switch 185 is configured to provide a screen processed at the first processor 170 and a screen processed by the upgrade apparatus 200, to the display 180. The switch 185 may perform switching based on a control of the controller 160 or the host controller 250. The switch 185 may be controlled so that only one of a screen processed at the first processor 170 and a screen provided from the upgrade apparatus 200 is provided to the display 180. The user may select a screen using remote control, buttons on the main body or touch screen.

In this example, the upgrade apparatus 200 includes a second interface 210, a memory 220, a clock signal generator 230, a second processor 240, a host controller 250, and a CAM 260. The clock signal generator 230, the second processor 240, the host controller 250 and the CAM 260 may be integrated into one integrated circuit (IC) 1120, but not limited thereto.

The TS and the clock frequency received from the broadcast receiving apparatus 100 through the second interface 210 may be stored in the memory 220. The host controller 250 provides the clock frequency to the clock signal generator 230 to control the clock signal generator 230 to generate a clock signal. The clock signal generator 230 generates clock signal based on the clock frequency and provides the clock signal to the second processor 240.

The second processor 240 detects TS stored in the memory 220 based on the clock signal and process decoding. For example, the second processor 240 may generate an STC using sync information such as PCR that is included in the TS and the clock signal, and decode video and audio data using the generated STC.

When the TS is encrypted, the host controller 250 provides the TS to the CAM 260. When the broadcast receiving apparatus 100 detects additional information such as data rate or the like in addition to the frequency information of the clock signal, the host controller 250 may provide the TS to the CAM 260 in accordance with the detected data rate.

The CAM 260 performs descramble and decryption for the TS and provides the TS to the second processor 240. The second processor 240 decodes the demodulated TS according to the clock signal.

When the broadcast receiving apparatus 100 provides at least one screen in a multi-screen function mode, the host controller 250 may control the second processor 240 to generate the multi-screen by combining the screen generated by the second processor 240 and the screen received from the broadcast receiving apparatus 100. In this example, the host controller 250 provides the generated multi-screen to the broadcast receiving apparatus 100 via the second interface 210.

The broadcast receiving apparatus 100 may output only one content or two or more contents, for example, based on a number or performance of tuners or video decoders. The broadcast receiving apparatus 100 may not be able to support a multi-screen function. In this example, the upgrade apparatus 200 may be connected to support the multi-screen function by the first processor 170 provided in the broadcast receiving apparatus 100 and the second processor 240 provided in the upgrade apparatus 200. Accordingly, the second processor 240 of the upgrade apparatus 200 may generate a new UI screen including an upgraded function, using graphic processor, and provide the generated screen to the broadcast receiving apparatus. Accordingly, the upgrade apparatus 200 may be used to generate a multi-screen function when the broadcast receiving apparatus 100 is incapable of supporting such a function on its own.

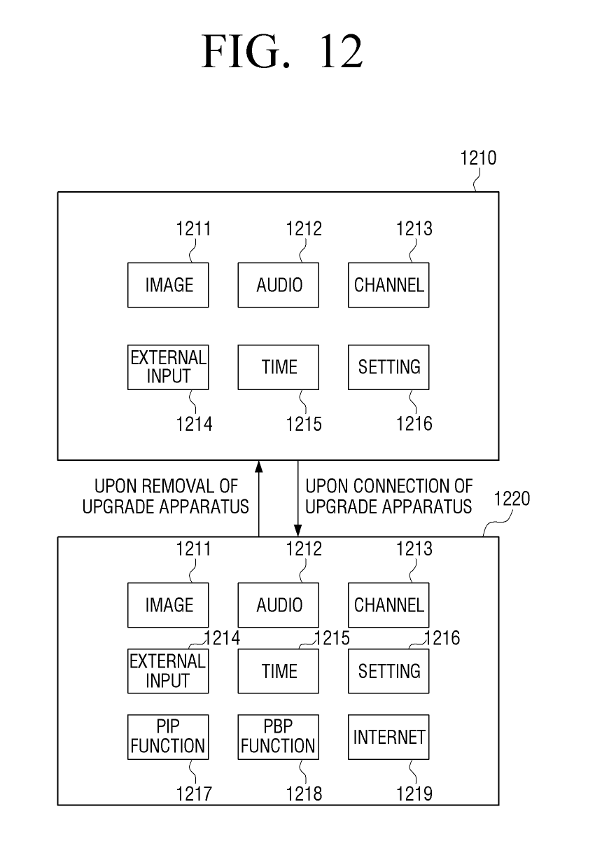

FIG. 12 illustrates an example of a UI screen that is changed in response to connection to the upgrade apparatus 200 according to an exemplary embodiment. Referring to FIG. 12, while the upgrade apparatus 200 is disconnected, the broadcast receiving apparatus 100 displays the UI screen 1210 which includes icons 1211-1216 representing functions that are supported by the broadcast receiving apparatus 100.

In response to the upgrade apparatus 200 being connected to the broadcast receiving apparatus 100, the second processor 240 generates UI screen 1220 and provides the generated screen to the broadcast receiving apparatus 100. The UI screen 1220 includes icons 1217-1219 in addition to the existent icons 1211-1216. The new icons include a PIP function icon 1217, a PB function icon 1218, and an Internet icon 1219.

In an example in which the broadcast receiving apparatus 100 is capable of performing multi-screen function, the multi-screen function may be further updated in response to the upgrade apparatus 200 being connected to the broadcast receiving apparatus 100. For example, a multi-screen that that is limited to a number of screens such as two screens may be able to display four screens when the upgrade apparatus 200 is connected.

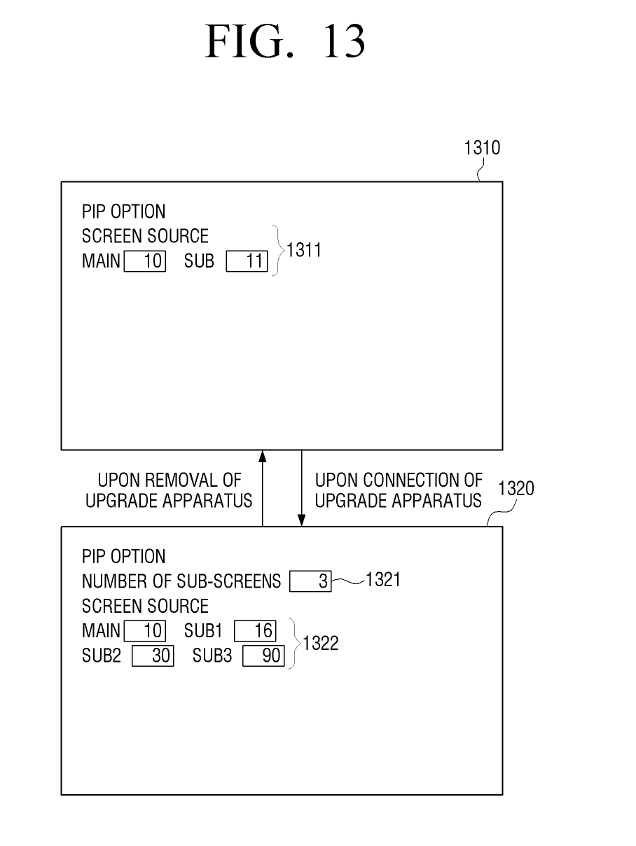

FIG. 13 illustrates an example of a UI screen to set an option of a multi-screen function according to an exemplary embodiment. Referring to FIG. 13, upon connecting and disconnecting the upgrade apparatus 200, the UI screen of the broadcast receiving apparatus 100 changes in form. For convenience of explanation, the UI screen before connecting is referred to as a first UI screen 1310, and the UI screen after connecting is referred to as a second UI screen 1320.

In this example, the broadcast receiving apparatus 100 is able to additionally display only one sub screen in addition to the main screen. Accordingly, the first UI screen 1310 includes an area 1311 to select the sources of the contents to be displayed on the main screen and sub screen. After connecting the upgrade apparatus 200, the second UI screen 1320 includes an area 1321 to select an amount of sub screens and an area 1322 to select a source of the screen.

For example, the broadcast receiving apparatus 100 and the upgrade apparatus 200 may each be able to process two contents for a total of four screens, including main and sub screens. Accordingly, the user may select one to three sub screens on the screen number select area 1321. Here, the number of areas to select sources displayed on the screen source select area 1322 may vary, depending on the number of screens selected by the user. For example, when the number of selected sub screens is 3, the screen source select area 1322 may include a select area to select sources of contents to be displayed on the main screen and sub screens 1 to 3.

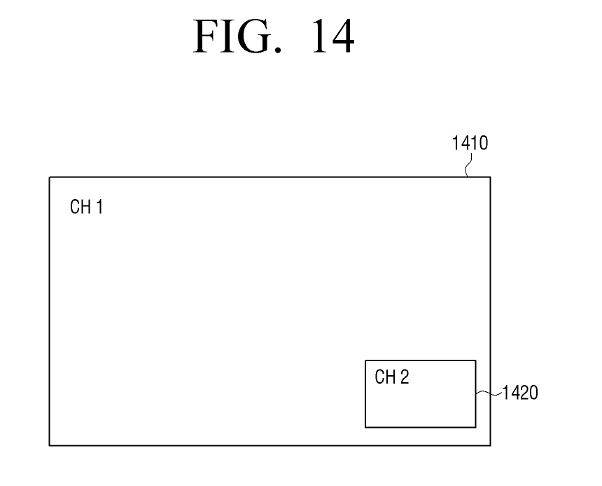

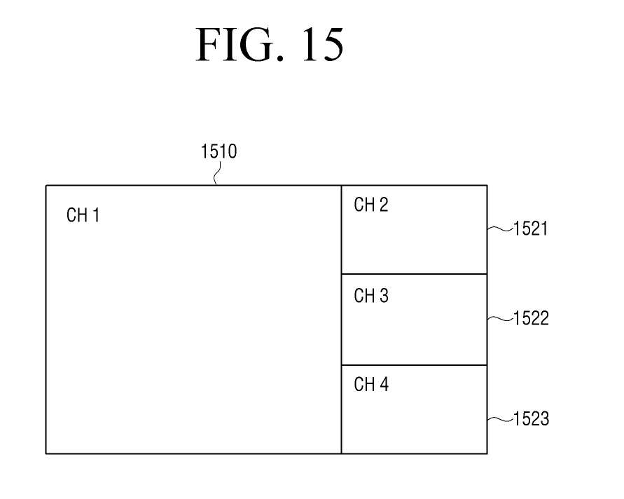

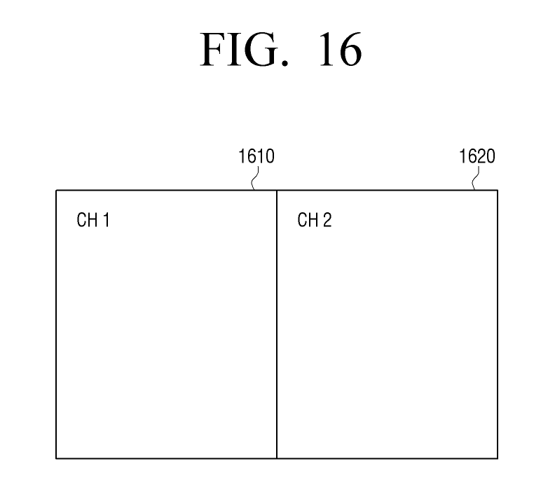

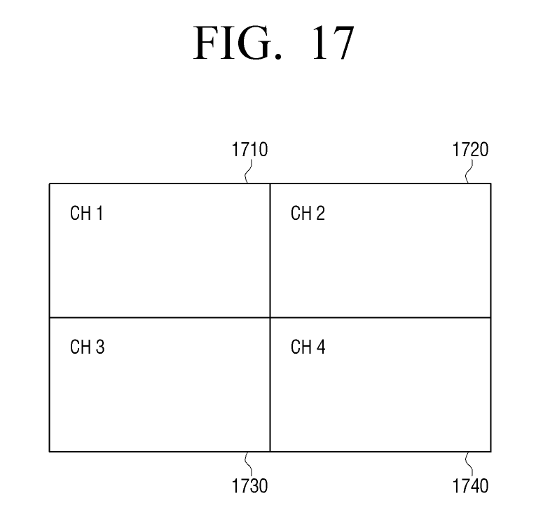

FIGS. 14 to 17 illustrate a multi-screen according to various exemplary embodiments. FIG. 14 illustrates an example in which one sub screen 1420 is displayed in a smaller size on a side of the main screen 1410. FIG. 15 illustrates an example in which three sub screens 1521, 1522, and 1523 are displayed vertically on one edge of the main screen 1510. FIG. 16 illustrates an example of a PBP function in use, in which case two same-sized screens 1610 and 1620 are displayed in parallel. FIG. 17 illustrates an example in which four same-sized screens 1710-1740 are displayed in a matrix arrangement. During processing of free-of-charge contents and/or charged contents, the broadcast receiving apparatus 100 and the upgrade apparatus 200 may combine the screens to provide a variety of forms of multi-screens in addition to the examples illustrated in FIGS. 14 to 17.

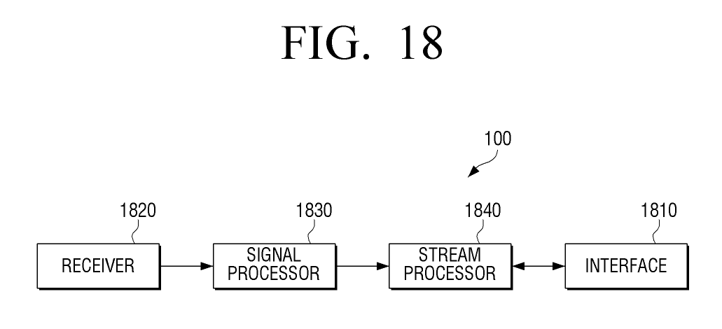

FIG. 18 illustrates a broadcast receiving apparatus 100 according to another exemplary embodiment. Referring to FIG. 18, the broadcast receiving apparatus 100 includes an interface 1810, a receiver 1820, a signal processor 1830, and a stream processor 1840.

The interface 1810 may be connected to the upgrade apparatus 200. For example, the interface 1810 may be implemented as a USB, PCl2, Serdes interface, and the like. The receiver 1820 may be used to tune to a broadcast channel and receive a broadcast signal of the broadcast channel. The received broadcast signal is provided to the signal processor 1830 which processes the received broadcast signal and detects a TS. For example, the signal processor 1830 may include a demodulator, an equalizer, a channel decoder, and the like.

The stream processor 1840 detects a clock frequency of the detected TS and provides the TS and the clock frequency to the upgrade apparatus 200 via the interface 1810. For example, the stream processor 1840 may include the frequency detector 140, the frequency storage 150, the controller 160 or the first processor 170 of the broadcast receiving apparatus 100 illustrated in FIG. 11.

In multi-screen function mode, the stream processor 1840 processes at least one first TS from among a plurality of TSs detected from a plurality of broadcast signals received through a plurality of broadcast channels and generates at least one first screen. The stream processor 1840 provides the generated screen to the upgrade apparatus 200. Furthermore, the stream processor 1840 provides at least one second TS from among the plurality of TSs and a clock frequency of the second TS to the upgrade apparatus 200. For example, the stream processor 1840 may be implemented as one system on chip (SoC).

Referring to FIG. 18, the broadcast receiving apparatus 100 may be a TV, a set-top box, a computer, and the like. For example, when implemented as a set-top box, the broadcast receiving apparatus 100 may transmit the content provided from the upgrade apparatus 200 to an external display apparatus.

When implemented as a TV, the broadcast receiving apparatus 100 may additionally include or be attached to a display and a speaker, in which case any reproduced content reproduced by the upgrade apparatus 200 may be displayed. In the multi-screen function mode, the display displays a multi-screen provided from the upgrade apparatus 200. The multi-screen may include at least one first screen generated by the stream processor 1840 and at least one second screen generated by the upgrade apparatus 200.

In addition to the multi-screen function, the upgrade apparatus 200 may also provide a multi view function. The multi view function herein refers to alternately displaying a plurality of different contents. The multi view may also be referred to as a dual view when two contents are displayed, a triple view when three contents are displayed, a quadruple view when four contents are displayed, and the like, but for convenience of explanation, all these will be collectively referred to as a multi view function or multi view mode.

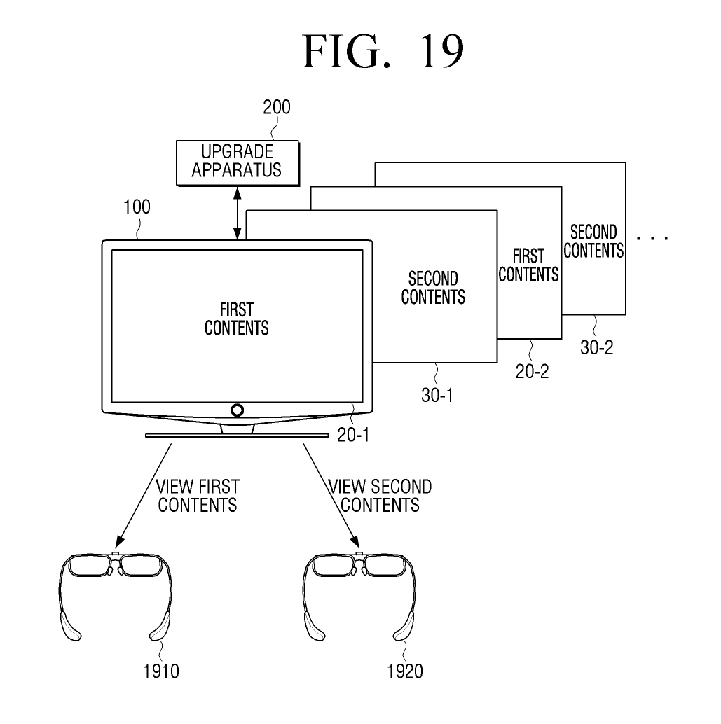

FIG. 19 is a diagram illustrating an operation of a broadcast signal processing system performing a multi view function according to an exemplary embodiment. The broadcast receiving apparatus 100 processes a first TS from first content and provides a screen of the first content to the upgrade apparatus 200. Separately, the broadcast receiving apparatus 100 may also provide a second TS and a clock frequency of the second TS to the upgrade apparatus 200.

The upgrade apparatus 200 generates a clock signal using the clock frequency and reproduces second contents of the second TS based on the clock signal. For example, the upgrade apparatus 200 may combine the first content screen and the second content screen to generate a multi view. Accordingly, the upgrade apparatus 200 may generate a multi view in various manners, depending on types of broadcast receiving apparatus 100 in use.

FIG. 19 illustrates an active type example according to an exemplary embodiment. The active type upgrade apparatus 200 alternately combines first content screens 20-1 and 20-2 and second content screens 30-1 and 30-2 and displays the result, in a sequential order, through the display of the broadcast receiving apparatus 100. FIG. 19 illustrates an example in which the first and second content screens are arranged alternately, but other examples are possible. For example, the screens may be alternately arranged based on a unit of a plurality of content screens.

The broadcast receiving apparatus 100 or the upgrade apparatus 200 may generate a sync signal and output the same such that glasses 1910 and 1920 are synchronized with the display timings of the respective content screen. The sync signal may be transmitted in various manners. For example, the sync signal may be transmitted by a broadcasting IR signal or RF signal, according to a wireless communication protocol such as Bluetooth, WiFi, Zigbee, IEEE, and the like.

FIG. 19 illustrates glasses 1910 and 1920 which may be shutter type glasses that include liquid crystal shutters. The shutter type refers to a way of individually controlling polarization direction by individually turning on or off the shutter of a left-eye glass and a right-eye glass, respectively. The first glasses 1910 matched with the first content turns on left-eye and right-eye of the glasses in accordance with the output timing of the first content screens 20-1 and 20-2, and turns off left-eye and right-eye of the glasses in accordance with the output timing of the second content screens 30-1 and 30-2. Accordingly, the user wearing the first glass device 1910 views only the first content. Likewise, the second glasses 1920 matched with the second content turns on respective glasses in accordance with the output timing of the second content screen. Accordingly, the user wearing the second glass device 1920 views only the second content.

In some examples, the broadcast receiving apparatus 100 is not able to provide the multi view function explained with reference to FIG. 19. In this example, when the upgrade apparatus 200 is connected to the broadcast receiving apparatus 100, the broadcast receiving apparatus 100 may directly decode a first TS and provide the result to the upgrade apparatus 200. Further, the broadcast receiving apparatus 100 may provide the upgrade apparatus 200 with a second TS and clock frequency information thereof. Accordingly, the upgrade apparatus 200 may generate a clock signal according to the clock frequency information and generate a second content screen by processing the second TS according to the clock signal.

The upgrade apparatus 200 may provide the first content screen and the second content screen processed at the broadcast receiving apparatus 100 in a sequential order and display the result. The upgrade apparatus 200 may include a sync signal generating module that may output a sync signal to synchronize the respective glasses 1910 and 1920 according to output timings of the first and second content screens. As another example, if the broadcast receiving apparatus 100 is able to process two contents, the broadcast receiving apparatus 100 may be upgraded to support a triple mode, a quadruple mode, and the like, while connected to the upgrade apparatus 200.

FIG. 19 illustrates an example in which active shutter glasses are used. As another example, passive type glasses may also be used. Accordingly, the upgrade apparatus 200 may divide the first and second content screens into a plurality of lines and generate a video frame by alternately aligning the divided lines. For example, the upgrade apparatus 200 may generate a first frame by combining an odd-numbered line of the first frame of the first content screen with an even-numbered line of the first frame of the second content screen. The upgrade apparatus 200 may also generate a second frame by combining an even-numbered line of the first frame of the first content screen with an odd-numbered line of the first frame of the second content screen. The second processor 240 of the upgrade apparatus 200 may generate a plurality of frames in a successive manner and provide the same to the broadcast receiving apparatus 100.

The display 180 of the broadcast receiving apparatus 100 may divide the respective frames in lines, and display the lines in such a manner that polarization directions of the respective lines are orthogonal to each other. In this example, the glasses 1910 and 1920 may not have shutter glasses, and instead the left-eye and right-eye of the glasses may be implemented as passive glasses with the same polarization direction. The passive type multi view glasses may have the same polarization direction in the left-eye and the right-eye of the glasses. When the first glasses 1910 pass the light in the first polarization direction, the odd-numbered line of the first frame and the even-numbered line of the second frame are perceived by the user wearing the first glass device 1910. On the contrary, when the second glasses 1920 pass the light of the second polarization direction, the even-numbered line of the first frame and the odd-numbered line of the second frame are those that are perceived by the user of the second glasses 1920.

Although an example in which the upgrade apparatus 200 directly generates the multi view and provides the same to the broadcast receiving apparatus 100 is described herein, the embodiments are not limited to any specific example. Accordingly, an active type may alternately provide the first content screen generated by the first processor 170 and the second content screen generated by the second processor 240 of the upgrade apparatus 200 using the switch 185.

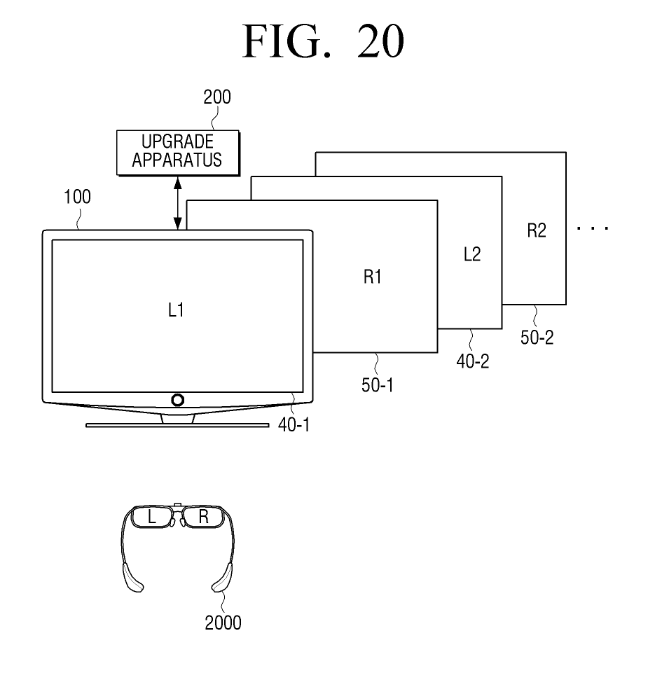

As explained, the broadcast receiving apparatus 100 may be upgraded to be able to support not only the multi view function, but also a three dimensional (3D) display function, when combined with the upgrade apparatus 200. FIG. 20 is a diagram illustrating a method for performing a 3D display function according to an exemplary embodiment.

Referring to FIG. 20, the upgrade apparatus 200 may generate left-eye images 40-1 and 40-2 and right-eye images 50-1 and 50-2 and provide the images to the broadcast receiving apparatus 100. When the upgrade apparatus 200 additionally includes a 2D-3D converter, the broadcast receiving apparatus 100 receiving 2D content may convert the received content into 3D content and output the result. For example, the broadcast receiving apparatus 100 may receive a TS corresponding to 2D, detect a clock frequency of the TS, and transmit the detected clock frequency and the TS to the upgrade apparatus 200.

The memory 220 of the upgrade apparatus 200 may store the clock frequency and the TS and the clock signal generator 230 may generate a clock signal using the clock frequency. The second processor 240 may decode the TS based on the generated clock signal and provides the same to the 2D-3D converter (not illustrated).

The 2D-3D converter may generate left-eye and right-eye images based on the decoded video frame. For example, the 2D-3D converter may divide the 2D video frame into a group unit. The 2D-3D converter may divide the respective video frames into a plurality of areas, and extract a depth map using the motion information of the respective divided areas. The 2D-3D converter may shift the respective pixels of the video frame based on the extracted depth map and generate a synthesized frame.

The second processor 240 may alternately arrange an original video frame and a synthesized frame and provide the result to the broadcast receiving apparatus 100. When the original video frame is used as the left-eye image, the synthesized frame may be used as a right-eye image, or vice versa. As a result, the broadcast receiving apparatus 100 may alternately display the left-eye images 40-1 and 40-2 and right-eye images 50-1 and 50-2.

The glasses 2000 may drive a left-eye glass in sync with the output timing of the left-eye image, and drive a right-eye glass in sync with the output timing of the right-eye image. Accordingly, a user wearing the glasses 2000 may view the contents with feeling of depth and thus experience a three-dimensional image. As explained, the upgrade apparatus 200 may provide a sync signal using a sync signal generating module.

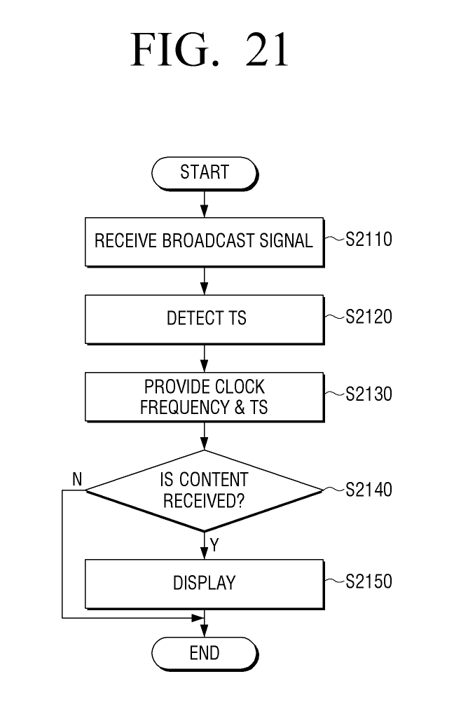

FIG. 21 is a flowchart illustrating a broadcast signal processing method according to an exemplary embodiment. Referring to FIG. 21, at S2110 the broadcast receiving apparatus 100 receives a broadcast signal, and at S2120 detects a TS from the received broadcast signal. At S2130, after detecting a clock frequency of the TS, the broadcast receiving apparatus 100 transmits or otherwise provides the detected clock frequency and the TS to the upgrade apparatus 200. For example, the broadcast receiving apparatus 100 may transmit the TS and the clock frequency directly, or in another embodiment, may store the TS and the clock frequency in the memory inside the broadcast receiving apparatus 100 such that the host controller 250 of the upgrade apparatus 200 may directly read out the stored information.

At S2140, the upgrade apparatus 200 reproduces content within the TS using the clock frequency, and the broadcast receiving apparatus 100 receives the content. Accordingly, at S2150, the received content is displayed. It should be appreciated that the broadcast receiving apparatus 100 does not have to display the received content only, and can also display the content processed therein, for example, depending on user selection.

In examples in which the multi-screen function is supported, an operation may involve a variety of operation steps including, tuning to a plurality of broadcast channels and detecting a plurality of TSs, processing at least one first TS among the plurality of TSs, generating at least one first screen and providing the same to upgrade apparatus 200, providing at least one second TS among the plurality of TSs and clock frequency of the second TS to the upgrade apparatus 200, displaying multi-screen in response to reception of multi-screen from the upgrade apparatus 200 in which first and second screens are combined, and the like. Additionally, a multi view function and/or a 3D display function may be supported.

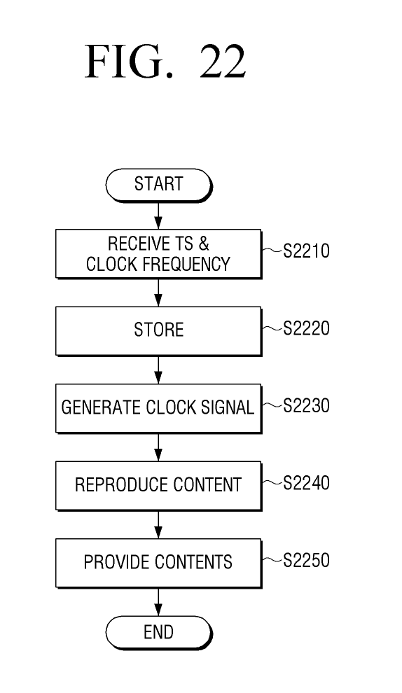

FIG. 22 is a flowchart illustrating a broadcast signal processing method of the upgrade apparatus 200, according to an exemplary embodiment. Referring to FIG. 22, at S2210, the upgrade apparatus 200 receives a TS and a clock frequency from the broadcast receiving apparatus.

At S2220, the received TS and clock frequency are stored at an internal memory 220 of the upgrade apparatus 200. At S2230, the upgrade apparatus 200 generates a clock signal that has the same frequency as the stored clock frequency. Based on the clock signal, at S2240 the TS is processed and content included in the TS is reproduced. At S2250, the upgrade apparatus 200 provides the reproduced content to the broadcast receiving apparatus 100. In this example, TS processing is performed without requiring a clock signal to be directly provided to the upgrade apparatus 200 or a broadcast signal to be directly input. As a result, a variety of screens can be provided, by utilizing signal processing blocks of the broadcast receiving apparatus 100 and signal processing blocks of the upgrade apparatus 200.

For example, when at least one screen processed at the broadcast receiving apparatus 100 in multi-screen function mode is received, the broadcast signal processing method of the upgrade apparatus 200 may additionally include an operation of providing a multi-screen, to the broadcast receiving apparatus 100, a result of combining screens generated by the upgrade apparatus 200.

According to various aspects, the upgrade apparatus 200 may provide a variety of upgraded functions using a clock frequency provided from the broadcast receiving apparatus 100. The various embodiments including those explained above, broadcast signal processing methods, multi-screen providing methods, multi view providing methods, or 3D display methods may be encoded into software that is recorded in a non-transitory readable medium and executable by a processor. The non-transitory readable medium may be included in a broadcast receiving apparatus 100 or a upgrade apparatus 200 to be used.

The ‘non-transitory readable medium’ herein may refer to a device-readable medium which permanently or semi-permanently stores data, rather than a medium such as register, cache, or memory that holds data for a short period of time. A CD, DVD, hard disk, Blue-ray disk, USB, memory card, ROM, and the like are examples.

The foregoing exemplary embodiments and advantages are merely exemplary and are not to be construed as limiting the exemplary embodiments. The present teaching can be readily applied to other types of apparatuses. Also, the description of the exemplary embodiments are intended to be illustrative, and not to limit the scope of the claims.

What is claimed is:

1. A broadcast signal processing system comprising:
a broadcast receiving apparatus configured to receive a broadcast signal and detect a clock frequency of a transport stream included in the broadcast signal; and
an upgrade apparatus configured to process the transport stream based on the clock frequency and provide content included in the processed transport stream to the broadcast receiving apparatus,
wherein the broadcast receiving apparatus is configured to output the content provided from the upgrade apparatus.

2. The broadcast signal processing system of claim 1, wherein the broadcast receiving apparatus comprises:
a receiver configured to tune to a broadcast channel and receive the broadcast signal;
a first interface configured to connect to the upgrade apparatus;
a signal processor configured to process the broadcast signal and detect the transport stream;
a first processor configured to process the transport stream;
a display configured to display a screen generated by the first processor;
a frequency detector configured to detect the clock frequency of the transport stream;
a frequency storage configured to store the clock frequency; and
a controller configured to provide the upgrade apparatus with the transport stream and the clock frequency via the first interface.

3. The broadcast signal processing system of claim 2, wherein the controller is configured to control the display to selectively display one of the content provided from the upgrade apparatus and the screen generated by the first processor.

4. The broadcast signal processing system of claim 2, wherein, the controller is configured to, in a multi-screen function mode, detect a plurality of transport streams from among a plurality of broadcast signals received from a plurality of broadcast channels, control the first processor to process a first transport stream among the plurality of transport streams to generate a first screen, provide the first screen to the upgrade apparatus, and provide a second transport stream among the plurality of transport streams and a clock frequency of the second transport stream to the upgrade apparatus,
the upgrade apparatus is configured to generate a multi-screen by combining a second screen that is a result of processing the second transport stream with the first screen, and provide the multi-screen to the broadcast receiving apparatus, and
the display is configured to display the multi-screen provided from the upgrade apparatus.

5. The broadcast signal processing system of claim 2, wherein, the controller is configured to, in a multi-screen function mode, detect a plurality of transport streams from among a plurality of broadcast signals received from a plurality of broadcast channels, control the first processor to process a first transport stream among the plurality of transport streams to generate a first screen, provide the first screen to the upgrade apparatus, and provide a second transport stream among the plurality of transport streams and a clock frequency of the second transport stream to the upgrade apparatus,
the upgrade apparatus is configured to generate a second screen by processing the second transport stream, and provide the second screen to the broadcast receiving apparatus,
the first processor of the broadcast receiving apparatus is configured to generate a multi-screen by combining the first screen with the second screen, and
the display is configured to display the generated multi-screen.

6. The broadcast signal processing system of claim 2, wherein the upgrade apparatus comprises:
a second interface configured to connect to the first interface of the broadcast receiving apparatus;
a memory configured to store the transport stream received from the broadcast receiving apparatus and store the clock frequency;
a clock signal generator configured to generate a clock signal based on the clock frequency;
a second processor configured to detect the transport stream stored by the memory according to the clock signal, process the detected transport stream, and reproduce the content; and
a host controller configured to provide the content to the broadcast receiving apparatus via the second interface.

7. A broadcast receiving apparatus comprising:
an interface configured to connect to an upgrade apparatus;
a receiver configured to tune to a broadcast channel and receive a broadcast signal;
a signal processor configured to process the broadcast signal and detect a transport stream from the processed broadcast signal; and
a stream processor configured to detect a clock frequency of the transport stream and provide the transport stream and the clock frequency to the upgrade apparatus.

8. The broadcast receiving apparatus of claim 7, wherein the stream processor comprises:
a frequency detector configured to detect the clock frequency of the transport stream;
a frequency storage configured to store the clock frequency; and
a controller configured to transmit the clock frequency and the transport stream to the upgrade apparatus via the interface.

9. The broadcast receiving apparatus of claim 7, further comprising a display configured to display content included in the transport stream that is reproduced by and received from the upgrade apparatus via the interface.

10. The broadcast receiving apparatus of claim 7, wherein the stream processor comprises a first processor configured to process the transport stream, and the controller is configured to control the display to selectively display one of a screen provided from the upgrade apparatus and a screen generated as a result of processing of the transport stream by the first processor of the broadcast receiving apparatus.

11. The broadcast receiving apparatus of claim 9, wherein the stream processor is configured to, in a multi-screen function mode, process a first transport stream from among a plurality of transport streams detected from a plurality of broadcast signals received through a plurality of broadcast channels, provide the processing result to the upgrade apparatus, and provide a second transport stream among the plurality of transport streams and a clock frequency of the second transport stream to the upgrade apparatus, and
the display is configured to display a multi-screen in response to receiving the multi screen from the upgrade apparatus which combines a second screen which is a result of processing the second transport stream with the first screen.

12. The broadcast receiving apparatus of claim 9, wherein the stream processor is configured to, in a multi-screen function mode, process a transport stream from among a plurality of transport streams detected from a plurality of broadcast signals received through a plurality of broadcast channels to generate a first screen, provide the processing result to the upgrade apparatus, and provide a second transport stream among the plurality of transport streams and a clock frequency of the second transport stream to the upgrade apparatus, and
in response to receiving a second screen from the upgrade apparatus which is a result of processing the second transport stream, the display is configured to display a multi-screen combining the first screen and the second screen.

13. The broadcast receiving apparatus of claim 10, further comprising a condition access module (CAM) configured to process an encrypted content,
wherein the displayed screen further comprises a content screen decrypted by the CAM.

14. The broadcast receiving apparatus of claim 8, wherein the frequency detector detects the frequency using:
$${t}_{TS} = {N}_{TS} * {T}_{ref} \text{/} {N}_{ref} , {F}_{TS} = \frac{1}{{t}_{TS}}$$
where t_{TS} denotes a clock periodicity, N_{TS} is a number of transport stream clocks, T_{ref} is a reference clock periodicity, N_{ref} is a number of reference clocks, and F_{TS} is a clock frequency.

15. An upgrade apparatus comprising:
an interface configured to connect to a broadcast receiving apparatus and receive a transport stream of a broadcast signal and a clock frequency from the broadcast receiving apparatus;
a memory configured to store the transport stream and the clock frequency; and
a stream processor configured to reproduce content included in the transport stream by processing the transport stream using the clock frequency and provide the processed content to the broadcast receiving apparatus via the interface.

16. The upgrade apparatus of claim 15, wherein the stream processor comprises:
a clock signal generator configured to generate a clock signal based on the clock frequency;
a second processor configured to detect the transport stream stored at the memory according to a data rate corresponding to the generated clock signal, and process the detected transport stream to reproduce the content; and
a host controller configured to provide the broadcast receiving apparatus with the reproduced content via the interface.

17. The upgrade apparatus of claim 16, wherein, the host controller is configured to, in a multi-screen function mode, control the processor to process the transport stream received from the broadcast receiving apparatus to generate a second screen, and provide the broadcast receiving apparatus with a multi-screen in which a first screen processed by the broadcast receiving apparatus and the second screen processed by the upgrade apparatus are combined.

18. A broadcast signal processing method of a broadcast signal processing system comprising a broadcast receiving apparatus and a upgrade apparatus connected to the broadcast receiving apparatus, the broadcast signal processing method comprising:
receiving, at the broadcast receiving apparatus, a broadcast signal and detecting a clock frequency of a transport stream included in the broadcast signal;
generating, at the upgrade apparatus, a clock signal based on the clock frequency and reproducing content included in the transport stream by processing the transport stream based on the generated clock signal; and
outputting, at the broadcast receiving apparatus, the reproduced content.

19. The broadcast signal processing method of claim 18, wherein the method further comprises, in a multi-screen function mode:
detecting, at the broadcast receiving apparatus, a plurality of transport streams from a plurality of broadcast signals received from a plurality of broadcast channels;
processing, at the broadcast receiving apparatus, a first transport stream from among the plurality of transport streams to generate a first screen, and providing the first screen to the upgrade apparatus;
providing, at the broadcast receiving apparatus, a second transport stream among the plurality of transport streams and a clock frequency of the second transport stream to the upgrade apparatus;
generating, at the upgrade apparatus, a second screen by processing the second transport stream; and
displaying, at the broadcast receiving apparatus, a multi-screen which is a result of combining the first screen and the second screen.

20. A broadcast signal processing method of a broadcast receiving apparatus to which an upgrade apparatus is connected, the broadcast signal processing method comprising:
tuning to a broadcast channel and receiving a broadcast signal;
decoding the broadcast signal and detecting a transport stream from the decoded broadcast signal;
detecting a clock frequency of the transport stream and providing the upgrade apparatus with the transport stream and the clock frequency; and
in response to receiving content from the upgrade apparatus which is reproduced based on the provided transport stream, displaying the content.

21. The broadcast signal processing method of claim 20, wherein the method further comprises, in a multi-screen function mode:
detecting a plurality of transport streams from among a plurality of broadcast signals received from a plurality of broadcast channels;
processing a first transport stream among the plurality of transport streams to generate a first screen and providing a result of the processing to the upgrade apparatus;
providing a second transport stream among the plurality of transport streams and a clock frequency of the second transport stream to the upgrade apparatus;
displaying a multi-screen which comprises a second screen which is a result of processing the second transport stream that is combined with the first screen.

22. A broadcast signal processing method of an upgrade apparatus connected to a broadcast receiving apparatus, the broadcast signal processing method comprising:
receiving a transport stream of a broadcast signal and a clock frequency from the broadcast receiving apparatus;
storing the transport stream and the clock frequency;
generating a clock signal using the clock frequency;
reproducing content included in the transport stream by processing the transport stream based on the generated clock signal; and
providing the reproduced content to the broadcast receiving apparatus.

23. The broadcast signal processing method of claim 22, further comprising, in response to receiving a screen processed by the broadcast receiving apparatus while in a multi-screen function mode, providing a multi-screen in which a screen of the content processed by the upgrade apparatus and the screen received from the broadcast receiving apparatus are combined.

24. An apparatus that externally connects to a broadcast display apparatus and processes content, the apparatus comprising:
a receiver configured to receive broadcast signal information from the broadcast display apparatus; and
a processor configured to process content that is displayed by the broadcast display apparatus based on a transport stream and clock cycle information included in the broadcast signal information received from the broadcast display apparatus.

25. The apparatus of claim 24, wherein the processor is configured to process the content by performing a function with the content that the broadcast display apparatus does not support on its own.

26. The apparatus of claim 24, further comprising an interface configured to externally attach and detach the apparatus to the broadcast display apparatus.

27. The apparatus of claim 24, wherein the clock cycle information comprises a clock frequency of the broadcast display apparatus, and the processor is further configured to generate a clock cycle based on the clock frequency and process the transport stream based on the generated clock cycle.

28. The apparatus of claim 24, wherein the clock cycle information comprises a clock cycle of the broadcast display apparatus, and the processor is further configured to process the transport stream based on the received clock cycle.

29. The apparatus of claim 24, wherein the processor is configured to process content by decoding the transport stream, reproducing content included in the transport stream, and transmitting the reproduced content to the broadcast display apparatus.
